(19) United States
(12) Patent Application Publication
(10) Pub. No.: US 2026/0333561 A1
(43) Pub. Date: Oct. 22, 2026

(54) COMPACT AND MODULAR ATMOSPHERIC PLASMA DEVICE FOR GENERATING SINGLE PLASMA MICRO-FILAMENTS

(71) Applicant: LEIBNIZ-INSTITUT FÜR PLASMAFORSCHUNG UND TECHNOLOGIE E.V., Greifswald (DE)

(72) Inventors: Laura BARILLAS-MORA, Greifswald (DE); Norbert LEMBKE, Greifswald (DE); Adrian LOPEZ-VASQUEZ, Greifswald (DE)

(73) Assignee: LEIBNIZ-INSTITUT FÜR PLASMAFORSCHUNG UND TECHNOLOGIE E.V., Greifswald (DE)

(21) Appl. No.: 19/696,369

(22) Filed: Jun. 3, 2026

Related U.S. Application Data
(63) Continuation of application No. PCT/EP2025/071229, filed on Jul. 23, 2025.

(30) Foreign Application Priority Data
Jul. 24, 2024 (EP) 24190754.2

(51) Int. Cl. H05H 1/48

(52) U.S. Cl. CPC H05H 1/481; H05H 1/486; H05H 2245/40

(57) ABSTRACT

Described herein is a transient spark discharge device configured to generate an atmospheric pressure plasma filament comprising a controller circuit connected to and configured to control a DC-voltage-driven driver circuit configured to generate a first signal at a first output, the first output being electrically connected to a piezoelectric transformer, the piezoelectric transformer configured to generate a second signal at a second output, wherein the second output is electrically connectable or connected to a nozzle comprising one or more electrically conductive electrodes connectable or connected to the second output (9), wherein each electrode comprises a conductive electrode tip, wherein each electrode comprises a hollow channel with a first opening at its electrode tip and a second opening at an opposite end of the channel, such that a feed gas may be flown from the second opening to the first opening for replenishing the feed gas at the electrode tip.

### CROSS-REFERENCE TO RELATED APPLICATIONS

This is a continuation of International Patent Application No. PCT/EP2025/071229, filed Jul. 23, 2025, which in turn claims priority to European Patent Application No. 24190754.2, filed Jul. 24, 2024, the contents of both of which are incorporated by reference herein in their entirety.

### FIELD

The invention relates to a compact and modular device that relates to an atmospheric plasma device for generating single plasma micro-filaments.

### BACKGROUND

In the art, plasma-generating devices are known.

Devices for producing a microscale plasma discharge are known; however, only very few are capable of producing a stable single-filament discharge, in particular for high-resolution maskless surface treatment.

The great majority of plasma jet-like devices that produce a micrometric footprint (filament diameter smaller than 500 μm) are based on a dielectric barrier discharge (DBD) configurations and/or comprise two electrodes—a high-voltage electrode and a grounded counter electrode. These electrodes are usually arranged concentrically, wherein an inner and an outer electrode are separated by a dielectric or an insulating material. Other kinds of discharge devices for producing single plasma filaments require an external and bulky high-voltage power supply in order to be operable.

In the art, hairline plasma devices are known that require a grounded counter-electrode to form the plasma filament. Therefore, any surface treatment is restricted to electrically conductive substrates, as the conductive counter-electrode is needed in order to create the plasma discharge. In the absence of the counter-electrode, the filament would not be produced. Moreover, such a device requires an external high-voltage DC power supply, and a high-resistance and current-limiting resistor is provided between the high-voltage electrode and the power supply. Hence, the transient spark discharge is based on the charging and discharging of the internal capacitance of the reactor, while the applied voltage drives the frequency and amplitude of the current pulses.

### SUMMARY

An object of the present invention is to provide a discharge device that overcomes the limitations of these devices known in the art.

The object is achieved by the discharge device having the features of claim 1.

Advantageous embodiments are described in the dependent claims.

According to a first aspect of the invention, an atmospheric pressure plasma device configured to generate a plasma filament comprises the following components:
a controller circuit connected to and configured to control
a DC-voltage-driven driver circuit configured to generate a first signal at a first output, wherein the controller circuit is configured to control at least one signal property of the first signal, such as an amplitude, a frequency and/or a shape of the first signal, wherein the first output is electrically connected to
a piezoelectric transformer, wherein the piezoelectric transformer is configured to generate a second signal at a second output, wherein the second output is electrically connectable or connected to
a nozzle comprising one or more electrically conductive electrodes connectable or connected to the second output, wherein each electrode comprises a conductive electrode tip, wherein each electrode comprises a hollow channel with a first opening at its electrode tip and a second opening at an opposite end of the channel, such that a feed gas may be flown from the second opening to the first opening for replenishing the feed gas at the electrode tip,
wherein the second signal is configured to cause a transient spark discharge at each electrode tip of the one or more electrodes, such as to generate a transient plasma filament at each electrode tip.

The first signal may comprise a first AC-voltage signal or a first pulse train.

The controller circuit may be configured to issue control signals for controlling and/or adjusting the at least one signal property of the first signal.

By controlling the first signal, the second signal may be adjusted, and thus the generation of plasma filaments.

Alternatively, or in addition, the controller circuit might comprise passive control elements, such as an adjustable resistance, capacitance, and/or inductance, that serve to control the signal property of the first signal.

Alternatively, the controller circuit may be configured to communicate wirelessly or via cable with an external control device to adjust the at least one signal property of the first signal. The external control device may be a computer with a respective communication interface, such as CANbus, ethernet, fieldbus, modbus, USB, or Bluetooth.

The signal property of the first signal may be selected from one or more from the group consisting of:
an amplitude of the first signal
a frequency of the first signal
a waveform of the first signal.

The controller circuit may be connected to the DC-voltage-driven driver circuit by means of a data connection plug, such as a USB connection.

The controller circuit may be comprised or emulated by a computer or a microchip.

Alternatively, the controller circuit may comprise an adjustable resistance, such as a potentiometer.

Particularly, the first signal comprises a first AC-voltage signal or a first pulse train. The AC-signal may be a sinusoidal signal, or any other periodic electrical AC-voltage signal.

The first pulse train may comprise square pulses or other pulses of the same or opposite polarity.

Particularly, the first signal generated by the DC-voltage-driven driver circuit is conditioned to excite the piezoelectric transformer to produce the second signal.

Particularly, the second signal comprises a second AC-voltage signal or a second pulse train. The AC-signal may be a sinusoidal signal, or any other periodic electrical AC-voltage signal.

The second pulse train may comprise square pulses or other pulses of the same or opposite polarity.

The piezoelectric transformer may particularly be configured to amplify the first signal to arrive at the second signal.

The second signal is stronger than the first signal. Particularly, the second signal comprises a second voltage signal or a second pulse train. The second signal may comprise a higher amplitude than the first signal. Particularly, the second signal carries a higher voltage than the first signal.

According to another embodiment of the invention, the nozzle is configured to be repeatedly electrically attachable and detachable to the piezoelectric transformer. This might be achieved by a repeatedly detachable mechanical connection comprising electrical connection as well.

This allows for using and exchanging the nozzle.

Particularly, the second signal is configured to cause an electric field at each electrode tip that is so high that a transient spark discharge may be ignited, which generates a highly reactive transient plasma filament along the channel-confined feed gas stream from each electrode tip. Particularly, the transient spark discharge is generated, particularly only if the feed gas is flown.

The channel-confined feed gas stream flows along the direction of the plasma filament, or in other words, the plasma filament may occur along the channel-confined feed gas stream.

The discharge device allows for a compact and modular device for generation of single plasma filaments at each electrode tip with an atmospheric pressure plasma, without a counter-electrode at a surface to be treated or without having the surface to be treated grounded with respect to the electrode of the discharge device. Particularly, the discharge device is devoid of a counter-electrode as well.

According to another embodiment of the invention, the controller circuit may further be configured to detect a presence of a nozzle.

According to another embodiment of the invention, the nozzle further comprises a verification element, comprising an electric circuit, wherein the verification element is configured to be detected by the controller circuit to verify a presence of the nozzle on the discharge device.

The verification element may further be configured to code for a unique nozzle-ID of the nozzle, operating parameters, such as an operating voltage. The verification element may be connected or connectable via the nozzle to the discharge device such that the controller circuit may detect the electric circuit.

Alternatively, the verification element may comprise an RFID component, wherein the controller circuit may be configured to read out the RFID component.

According to another embodiment of the invention, the discharge device comprises a nozzle with a single electrode only or with an array of multiple single electrodes that can be controlled together, in series or parallel, or independently to generate one or more single plasma filaments at the electrode tip(s).

For this purpose, the nozzle, and in particular the verification element of the nozzle, as well as the controller circuit may comprise corresponding elements to facilitate independent or collective generation of the plasma filaments.

According to another embodiment of the invention, the discharge device is devoid of a dielectric barrier element for producing a dielectric barrier discharge.

In contrast to device known in the art, the discharge device according to the invention, instead of using an external high-voltage DC input power supply or multiple successive circuits to generate a high voltage, the discharge device utilizes a solid-state device, namely the piezoelectric transformer that may transform electromechanical energy into electrical energy by means of a vibration applied to a piezo-element comprised by the piezoelectric transformer. The electromechanical energy may be generated from a vibration source that is driven by the first signal. The piezo element may be driven at resonance frequency, such that the second signal, e.g. the second pulse train or the second AC voltage signal is high enough to ignite a discharge in each electrode supplied by the feed gas.

According to another embodiment of the invention, the piezoelectric transformer is a step-up piezoelectric transformer.

Particularly, in comparison to discharge devices in the art, instead of a high-resistance element electrically arranged between the (high-voltage) electrode and a power supply of the discharge device, the discharge device according to the invention takes advantage of an internal electrical impedance of a piezo-element comprised by the piezoelectric transformer to limit a discharge current, which—if left unlimited—would cause the generated transient plasma filaments to transition to a thermal plasma, i.e. the plasma filaments would turn to an arc discharge plasma exhibiting a high electric current.

The usage of the piezoelectric transformer to power jet-like atmospheric-pressure plasma devices has been reported by several authors, but again, none of them describes or includes all the same elements mentioned in the current invention, which allows a compact and modular device, and if required, the possibility of battery operation. The great majority of these works report on the use of a DBD jet reactor configuration whose electrodes are powered by the piezoelectric transformer, while others are based on the principle of piezoelectric direct discharge (PDD), a combination of both, or they do not include a hollow high9-voltage electrode with a sharp end.

In piezoelectric direct discharge devices known in the art, there is no high-voltage electrode tip at which a plasma filament may be generated, instead, the entire surface of the piezoelectric transformer is used for the plasma ignition leading to a comparably undefined plasma region. In the specific case of plasma jets by PDD, as for example disclosed by Korzec et al, “Piezoelectric Direct Discharge: Devices and Applications”. Plasma. 2021; 4(1): 1-41. https://doi.org/10.3390/plasma4010001, the maximum electric field is generated at an edge of the piezo crystal, and the micro-discharges are developed as positive or negative streamers depending on the polarization of the piezoelectric transformer edge; for above reasons, due to the multitude of streamer dischargers, the footprint of PDD-based jets is diffuse and significantly larger several millimeters. This also applies even for the PDD-based device with a needle nozzle, in which the main component is a solid needle electrode; the latter is biased over the PDD plasma bridge, similar to a DBD electrode, shortcutting electrically the piezoelectric generator and the needle electrode head, treating only the electrically conducting surfaces. From the above, compared to the proposed invention, the device according to the invention is configured to produce a plasma filament based on a transient spark discharge at the tip of the hollow gas-fed high-voltage electrode, providing a filament diameter that is smaller than the plasma device in the art.

The invention provides a discharge device that is externally powered by a DC power source that provides only a comparably low DC voltage, e.g. in the range of 3V to 24V.

This DC voltage is boosted to several kilovolts by the discharge device.

A DC voltage required for driving the driver circuit may be in the range of 2V to 32V, particularly in the range of 3V to 24V, more particularly in the range of 3V to 20V.

According to another embodiment of the invention, the first signal, such as the first pulse train or the first AC voltage signal in the range of 100V to 400V, particularly in the range of 150V to 300V.

According to another embodiment of the invention, the piezoelectric transformer is configured to be driven by the first signal, conditioned by the controller circuit, in particular in resonance with the first signal.

According to another embodiment of the invention, the piezoelectric transformer is configured to amplify the first AC voltage by a factor of 5 to 20, particularly by a factor of 8 to 15.

It is noted that the second signal may not have a sinusoidal waveform, but may be a distorted periodic voltage signal or some kind of a pulse train. The voltage signal may be alternating in polarity, particularly in a periodic or quasi periodic fashion.

According to another embodiment of the invention, the second signal, e.g. the second pulse train or the second AC voltage signal is in the range of 0.3 kV to 15 kV, particularly in the range of 1 kV to 5 kV.

The second signal is high enough to ignite a discharge in the electrode tip of each of the electrodes and the channel-confined feed gas stream.

Advantageously, due to the pulsating nature of the second signal, e.g. the second pulse train or the second sinusoidal AC voltage signal, multiple micro-discharges may occur sequentially during a single period of the second signal.

As feed gas, a noble gas such as neon, helium, or argon may be used. Other gases or admixtures are possible.

Further, admixtures may be comprised in the feed gas.

The gas flow allows for generation of the plasma filament.

The term “filament” particularly refers to a line-like plasma region.

According to another embodiment of the invention, the discharge device is a counter-electrode-free discharge device.

The first and the second signal are voltage signals.

According to another embodiment of the invention, wherein each electrode is formed as a hollow needle, wherein a needle tip of the needle corresponds to the electrode tip.

Particularly, the channel of each electrode is formed as a hollow tube with a sharp tip, wherein the hollow tube with a sharp tip can be a needle, wherein a needle tip corresponds to the electrode tip.

The hollow channel is in essence enclosed by the needle, which is why the needle is hollow.

In particular, the nozzle comprising the one or more hollow needles is formed to be mechanically attachable and detachable from the discharge device.

This allows using a variety of nozzles with a variety of needles, depending on the application, the filament type that is required, and/or whether a one-time use needle is required, e.g. for reasons of sterility.

The needle-like shape of the electrode allows for generation of small filaments comprising small diameters. As a laminar gas flow is advantageous for the generation of well-defined plasma filaments from the electrode tip, the hollow channel of the hollow needle allows for laminar flow generation as the diameter of the hollow channel is limited by the needle. Laminarity of the gas flow depends, inter alia, from the diameter of the channel. The channel diameter, i.e. the inner diameter of the hollow needle, may be as small as of 0.01 mm to 0.8 mm and as great as 1 mm to 3 mm.

The needle may comprise a needle wall enclosing the hollow channel of the hollow needle. In particular, the needle wall may be made of an electrically conductive material.

According to another embodiment of the invention, the DC-voltage-driven driver circuit comprises a DC voltage input, wherein the DC-voltage-driven driver circuit is arranged and configured to generate from a DC voltage applied to the DC voltage input the first signal having the at least one signal property as controlled by the controller circuit.

According to another embodiment of the invention, the discharge device comprises or is connectable via the DC voltage input with a power source arranged and configured to provide the DC voltage to the DC-voltage-driven driver circuit.

The power source may be selected to generate a DC voltage in the range of 2V to 32V, particularly in the range of 3V to 24V, more particularly in the range of 3V to 20V.

For this, the power source may be a battery or comprise a wall plug connector configured to transform mains electricity e.g. 220V (AC) or 110V (AC) to 24V (DC) DC voltage.

Optionally, the DC voltage is provided to an electric circuit comprised or separate from the power source, wherein said electrical circuit is configured to regulate and limit the DC voltage to the specified value of the power source. In particular, the electric circuit is configured to keep the DC voltage constant.

The power source may be comprised by a housing of the discharge device or may be connectable via a connector to the discharge device.

According to another embodiment of the invention, the discharge device is configured to generate the transient plasma filament independently of a presence of a grounded counter electrode in a vicinity to the discharge device.

This embodiment specifies one advantageous aspect of the discharge device, namely the capability of the discharge device to generate plasma filaments without relying on the presence of a counter electrode. The absence of a counter electrode is thought to be compensated by the specific design of the discharge device, where the plasma filament forms as a result of the localized electric field at the electrode tip. This electric field is strong enough to create and sustain a plasma filament directly in the air or other gas mixtures surrounding the electrode.

In particular, the electrode of the discharge device is designed to have an electric field concentration at the electrode tip being highest with regard to other portions of the electrode. This allows ionization of the feed gas into plasma at atmospheric pressure, effectively generating plasma filaments directly and in particularly uniquely at the electrode tip.

This embodiment allows the discharge device to be used on non-conductive materials where traditional plasma devices that require a counter (grounded) electrode cannot operate.

According to another embodiment of the invention, the discharge device comprises a mounting system that comprises a first portion located on the discharge device and a second portion located on the nozzle, wherein the first and the second portion are configured to engage the nozzle with the discharge device.

This embodiment facilitates the mechanical and electrical attachment and detachment of the one or more electrodes comprised by the nozzle, thereby enhancing the device's usability and functionality. The mounting system comprises two main components: a first portion and a second portion.

The first portion is located on a body of the discharge device, and may be designed as a receptacle or a connector that serves as the interface for the nozzle. Particularly, the first portion is formed and designed to align with the second portion on the electrode, particularly in an essentially seamless fashion. The first portion may comprise mechanical features such as a clip, a socket, a threaded element, or a magnetic element that ensures a secure yet detachable connection between the body of the discharge device and the electrode. The first portion may be formed to withstand the electrical and mechanical stresses encountered during the operation of the discharge device.

The second portion is located on the nozzle. The second portion complements the first portion on the body of the discharge device. It may include corresponding mechanical features such as a tab, a plug, or a complementary threaded or magnetic element that are configured to align and to engage with the features on the first portion. The second portion is designed to ensure that when the electrode is attached, a stable and effective electrical connection is formed with the body of the discharge device, essential for the efficient generation of plasma filaments. The second portion may comprise the verification element.

The configuration of the mounting system is such that it provides a robust mechanical connection for safe and effective operation of the discharge device. The mounting system ensures that the one or more electrodes is/are precisely positioned relative to the body of the discharge device.

According to another embodiment of the invention, the one or more electrode(s) consist(s) of or comprise(s) a metal. The metal may be comprised by each electrode in form of a coating of an, particularly non-conductive, electrode substrate.

Alternatively, each electrode may consist of the metal.

According to another embodiment of the invention, the device is configured to generate a plasma filament having a diameter in the range of 5 μm to 200 μm, particularly in the range of 40 μm to 150 μm, more particularly in the range of 50 μm to 100 μm, particularly wherein a diameter is determined by a full width at half maximum of an intensity of the filament, particularly wherein the diameter may be determined at a distance of 0 mm to 50 mm away from the electrode tip in absence of an object or a counter electrode.

According to another embodiment of the invention, the discharge device is configured to generate a plasma filament having a diameter of less than 250 μm, particularly less than 100 μm, more particularly less than 50 μm, particularly wherein a diameter is determined by a full width at half maximum of an intensity of the filament, particularly wherein the diameter may be determined at a distance of 0 mm to 50 mm away from the electrode tip in absence of an object or a counter electrode.

The shape and size of the plasma filament in particular depend on a flow rate of the feed gas, and a width of the hollow channel, on the shape and a size of the electrode tip as well as on a laminarity or turbulence of the feed gas flow.

According to another embodiment of the invention, wherein the discharge device comprises one or more capillaries, wherein each capillary encloses one of the one or more electrodes at least radially.

That is, each capillary encloses one electrode along an axial extension direction of the electrode.

The capillary allows for insulating the electrode from the environment, allowing a safer handling, and/or the use of shielding gases.

Further, the capillary may be used to add an additional feed to the feed gas. This feed may comprise a different gas and/or particles to be induced in the plasma filament. Such particles could be ink particles, that cure or polymerize under the influence of plasma, so-called plasma curable ink or plasma curable precursors. Other particles may include solid micro or nanoparticles, flakes or similar, in a solution or in a dry state. This allows to write plasma-curable ink or plasma-treated particles with the device according to the invention.

The additional feed may consist of the same or other gases, or admixtures of gases.

In this embodiment, the plasma filament can exit the capillary with an adjusted gas flow and distance between the end of the capillary and the needle, e.g. 2-5 mm or even 0.1 mm to 4 mm.

The capillary, while not mandatory to the device, bears to at least two advantages:
the capillary protects a user, by electrically insulating the electrode at least in part, and it may protect a user of that the electrode e.g. in form of a needle may prick a finger of the user. Further, the capillary protects the needle against damage when the electrode is accidentally dropped. The capillary may prevent the electrode tip from bending in case of a drop or when touching a surface, which could cause the electrode tip to end up deformed such that the plasma discharge assumes an undesired shape.
The capillary may be formed to comprise a T-shape, or an additional space between the electrode and the capillary, which allows introduction of an additional feed. As elaborated, said feed may comprise a different gas than the feed gas, a gas-phase precursor, or an aerosol to deposit a material.

According to another embodiment of the invention, the discharge device comprises a gas source attached or attachable to the second opening of the channel of each electrode, wherein the gas source is configured to flow a feed gas or a feed gas mixture from the second opening through the channel toward the first opening of the channel.

The gas source may be attached to the one or more electrodes via the nozzle. The nozzle may comprise a single opening that distributes the feed gas to the second opening of each electrode.

The gas source may be configured to adjust or control a gas flow of the feed gas, such as to adjust the gas flow at the electrode tip to be laminar.

The electrode's hollow design in combination with the gas source facilitates a controlled flow of gas, such as neon, helium, or argon, which emerges from the tip of the electrode. This flow of gas maintains the plasma filament once initiated, ensuring that the filament can be sustained without the presence of a counter electrode.

According to another embodiment of the invention, wherein the DC voltage is in the range of 0V to 24V. In particular, the power source is configured to provide the DC voltage in said range.

The embodiment allows for a device that is drivable by a common DC voltage adapter for a mains voltage, e.g. 110V (AC) or 230V (AC) respectively.

Nonetheless, as transformation to high voltages is facilitated by the comparably small and lightweight piezoelectric transformer, the device can still be considered handheld, even when the power source is comprised by the device.

Further, connection plugs to the device from such as DC voltage adapter are well-known and well-established, so that the off-the shelf adapters may be used.

According to another embodiment of the invention, the first signal comprises a waveform selected from one of the group consisting of:
a sinusoidal waveform,
a pulse train,
a sawtooth waveform,
a triangular waveform,
a composite waveform.

In case the first signal is a pulse train, the pulse train may comprise a square pulse wave, wherein the square duration may be limited to be 50% of the frequency.

The composite waveform may be obtained by overlaying a number of periodic waveforms, e.g. according to the Fourier series.

According to another embodiment of the invention, the second signal comprises a waveform selected from one of the group consisting of:
A sinusoidal waveform,
A pulse train,
A sawtooth waveform,
A triangular waveform
A composite waveform.

In case the second signal is a pulse train, the pulse train may comprise a square pulse wave, wherein the square duration may be limited to be 50% of the frequency.

The composite waveform may be obtained by overlaying a number of periodic waveforms, e.g. according to the Fourier series.

Particularly, the second signal has the same waveform as the same as the first signal.

According to another embodiment of the invention, the gas source is configured to provide a gas flow between 0.1 sccm and 500 sccm.

This allows for controlling the gas flow and thus the shape and characteristics of the plasma filament. In particular, the flow may be adjusted to have a laminar flow at the electrode tip.

According to another embodiment of the invention, the discharge device comprises a compact housing that encloses the controller circuit, the DC-voltage-driven driver circuit, and the piezoelectric transformer, wherein the housing has a mechanical and electrical connection to the nozzle, wherein the nozzle has an opening through at which the one or more electrodes or the electrode tips is/are arranged such as a plasma filament may exit the nozzle, particularly wherein the housing or the nozzle comprise a handle portion, particularly wherein the device is configured to be handheld by the handle portion.

According to another embodiment of the invention, the discharge device is configured as a handheld device or mountable on a machine setup, allowing orienting the discharge device for use in any direction, particularly such that the device can be used for the modification, cleaning, coating, activation, etching or ablation of surfaces, for medical applications such as ablation and stimulation of biological material, and for other applications such as ignition of devices, and can be used together with or as a complement to other technologies including additive manufacturing, atomic layer deposition, chemical vapor deposition, laser surface treatment, and others.

According to another embodiment of the invention, the piezoelectric transformer comprises a plurality of piezoelectric transformer devices connected in series, such that each piezoelectric transformer device feeds into the next piezoelectric transformer device of the plurality of piezoelectric transformer devices to increase the second signal at the second output.

According to a second aspect of the invention, there is disclosed and claimed a plasma printing system comprising the transient spark discharge device according to the first aspect of the invention, wherein the system further comprises:
a substrate handling platform configured to position and secure a substrate for plasma treatment;
a multi-axis linear stage or a robotic arm configured to enable precise movement of the transient spark discharge device relative to the substrate
a gas supply system or systems configured to provide a feed gas, a feed gas mixture, or a gas-phase precursor to the transient spark discharge device;
a liquid-phase precursor dispensing system, such as a mist generator, aerosol generator, or droplet-on-demand system, configured to deliver precursors for plasma-assisted deposition;
a controller configured to coordinate the operation of the transient spark discharge device, the substrate handling platform, and the dispensing system.

By combining the transient spark discharge device with coordinated substrate handling, precise positioning, and controlled precursor delivery is achieved. The system, therefore, enables high-resolution plasma treatments at atmospheric pressure. This configuration allows for maskless, selective area treatments with potential micrometer-scale precision. The dual gas and liquid precursor delivery systems expand the range of processable materials and treatment types. The coordination via the controller facilitates multi-step processes.

According to another embodiment of the invention, the system is configured to perform multiple operations, including:
surface activation and cleaning,
maskless atmospheric-pressure plasma etching,
plasma-assisted additive manufacturing, and
plasma-enhanced atomic layer deposition.

This embodiment allows for a wide range of surface treatments using the same system.

According to another embodiment of the invention, the system is configured to achieve micrometric resolution for surface treatments, with a minimum linewidth resolution of 35 μm, or better, e.g. 10 μm.

The system allows for particularly high-resolution treatment of surfaces by using the device according to the first aspect.

According to another embodiment of the invention, the gas supply system is configured to provide a gas flow rate between 0.1 sccm and 500 sccm.

According to another embodiment of the invention, the system further comprises an enclosure configured to provide a controlled environment for plasma printing and etching operations, wherein the enclosure is configured to maintain a controlled atmosphere, including an inert or a temperature-controlled environment, for plasma operations.

The enclosure provides a controlled environment for plasma operations, enabling precise regulation of atmospheric conditions and temperature. This controlled setting enhances process stability and reproducibility.

According to another embodiment of the invention, the system further comprises a vacuum clamping system for securing the substrate during plasma printing or etching operations on the substrate handling platform.

The vacuum clamping system ensures precise and stable positioning of the substrate during plasma printing or etching operations, minimizing potential movement or distortion. This enhanced substrate stability contributes to improved accuracy and consistency of the plasma treatment, particularly for high-resolution or delicate processes that require precise alignment and minimal substrate displacement.

According to another embodiment of the invention, the system is configured to integrate with additional modules, including:
an additive manufacturing module,
a laser processing module,
a plasma-enhanced chemical vapor deposition (PE-CVD) module, and
an atomic layer deposition (ALD) module.

The integration of additional modules such as additive manufacturing, laser processing, PE-CVD, and ALD expands the system's capabilities, enabling complementary surface modification and material deposition techniques. This modular approach allows for seamless combination of multiple advanced manufacturing processes within a single platform, enhancing overall production efficiency.

According to another embodiment of the invention, the controller is configured to provide a human-machine interface for real-time monitoring and control of plasma printing and etching parameters.

According to another embodiment of the invention, the system is configured to perform selective area treatments without the use of masks.

The ability to perform selective area treatments without masks enables precise, localized surface modifications with reduced material waste and processing steps. This maskless approach allows for greater flexibility in pattern design and rapid prototyping, as changes can be implemented digitally without the need for new physical masks. Additionally, it may enable treatment of complex 3D surfaces or non-planar substrates that would be challenging or impossible to mask effectively using traditional methods.

According to another embodiment of the invention, the transient spark discharge device is configured to generate a plasma filament with a diameter in the range of 5 μm to 200 μm for precise surface treatments.

According to a third aspect of the invention, a method for plasma-assisted surface treatment with the device according to the first aspect of the invention, or the system according to the second aspect of the invention comprises the steps of:
generating a transient spark discharge at atmospheric pressure to produce a plasma filament at the tip of one or more electrodes;
positioning a substrate relative to the plasma filament, particularly using the substrate handling platform; and
performing a surface treatment operation selected from the group consisting of:
additive printing using a liquid-phase precursor,
additive printing or direct writing using a gas-phase precursor, and
maskless etching of thin films.

According to another embodiment of the invention, the plasma filament is generated using a sinusoidal-based transient spark discharge and a feed gas selected from the group consisting of argon, helium, or a mixture thereof, with an optional addition of reactive gases in concentrations less than 5%.

According to another embodiment of the invention, the additive printing operation comprises:
delivering a liquid-phase or the gas-phase precursor to the plasma filament, particularly using the dispensing system; and
depositing a thin film or patterned structure on the substrate through plasma-assisted polymerization or material synthesis.

According to another embodiment of the invention, the additive printing or direct writing operation comprises:
delivering a gas-phase precursor to the plasma filament; and
depositing a material directly onto the substrate in a single-step process.

According to another embodiment of the invention, the maskless etching operation comprises:
exposing a thin film on the substrate to the plasma filament; and
selectively removing the thin film to create high-resolution features with a linewidth resolution of at least 35 μm or better, e.g. 10 μm.

According to another embodiment of the invention, the maskless etching operation is performed on hydrophobic thin films, such as Teflon or Parylene, without the use of photoresists or masks.

According to another embodiment of the invention, the plasma-assisted additive printing operation is used to deposit materials selected from the group consisting of polymers, metals, metal oxides, and hybrid coatings.

According to another embodiment of the invention, the plasma-assisted direct writing operation is used to deposit conductive or dielectric materials for microelectronic applications.

According to another embodiment of the invention, the substrate is electrically connected to a ground potential.

According to another embodiment of the invention, the substrate is electrically isolated from the substrate handling platform.

According to another embodiment of the invention, the maskless etching operation is performed on metallic films or a film comprising a metal oxide or a metal composite, without the use of photoresists or masks.

According to another embodiment of the invention, the plasma filament is configured to generate high aspect ratio features with steep and well-defined borders on the substrate.

According to another embodiment of the invention, the substrate is positioned and secured using a vacuum clamping system during the surface treatment operation.

According to another embodiment of the invention, the surface treatment is performed in a controlled environment maintained by an enclosure, the environment being inert or temperature-controlled.

According to another embodiment of the invention, the transient spark discharge device is moved relative to the substrate using the multi-axis linear stage or robotic arm to achieve precise patterning.

According to another embodiment of the invention, the plasma-assisted surface treatment is coordinated by a controller configured to synchronize the operation of the transient spark discharge device, substrate handling platform, and precursor delivery system.

According to another embodiment of the invention, the plasma-assisted surface treatment is used to fabricate or modify structures for applications in microfluidics, microelectronics, semiconductors, biomedical devices, or thin-film manufacturing.

According to another embodiment of the invention, the plasma filament is configured to operate with a diameter in the range of 5 μm to 200 μm for precise surface treatments.

### BRIEF DESCRIPTION OF THE DRAWINGS

Particularly, exemplary embodiments are described below in conjunction with the Figures. The Figures are appended to the claims and are accompanied by text explaining individual features of the shown embodiments and aspects of the present invention. Each individual feature shown in the Figures and/or mentioned in said text of the Figures may be incorporated (also in an isolated fashion) into a claim relating to the device according to the present invention.

FIG. 1 shows an exemplary embodiment of the invention;

FIG. 2 shows a second exemplary embodiment of the invention;

FIG. 3 shows an exemplary embodiment of a nozzle with a single electrode;

FIG. 4 shows an exemplary embodiment of a nozzle with a plurality of electrodes;

FIG. 5 shows an exemplary embodiment of a nozzle with a single electrode, and a protective capillary;

FIG. 6 shows an exemplary embodiment of a nozzle with a single electrode, and a protective capillary with an additional feed opening;

FIG. 7 shows in panels A)-G) various photographs of the plasma filament produced by the device according to the invention.

FIG. 8 shows in panels A) and B) photographs of the plasma filament produced by the device comprising a protective capillary according to the invention

FIG. 9 shows a photograph of a plurality of plasma filaments produced by a plurality of electrodes comprised by the device according to the invention;

FIG. 10 shows an XPS recording of a silicon substrate with a partially removed Teflon film using the method according to the invention;

FIG. 11 shows a 3D-surface representation of an etched line into a Teflon covered silicon substrate;

FIG. 12 shows a schematic process of maskless etching using the discharge device according to the invention; and

FIG. 13 shows a flowchart depicting the workflow according to the method according to the invention.

### DETAILED DESCRIPTION

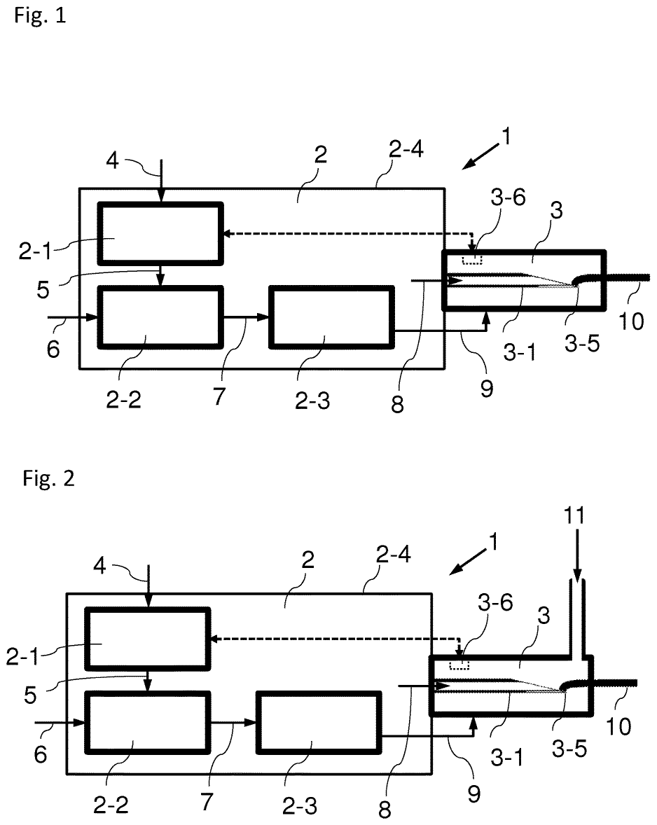

In FIG. 1 as well as in FIG. 2 a schematic drawing of a compact and modular transient spark discharge device 1 according to an exemplary embodiment of the invention is shown.

The transient spark discharge device 1 comprises a DC voltage-driven driver circuit 2-2 which is fed with a low-voltage 6, particularly a DC voltage in the range of 0V to 24V. The DC voltage-driven driver circuit 2-2 generates a first signal, for example in form of a pulse train or sinusoidal AC voltage signal 7 with the amplitude and frequency set by the controller circuit 2-1 that is connected to the DC voltage-driven driver circuit 2-2.

The controller circuit 2-1 may be a passive element, e.g. an adjustable resistor, that controls at least one property of the first signal, by way of a passive electric circuit. Alternatively, the controller circuit may be configured to generate a control signal to adjust the at least one property of the first signal. For this purpose, the controller circuit may be implemented in a computer or microprocessor or emulated by a computer connected to the DC voltage-driven driver circuit 2-2.

The provided DC voltage 6 may be provided by an external power source (not shown), e.g. a 24 V wall plug connector or a power signal. This DC voltage, is fed to the DC voltage-driven driver circuit 2-2. For example, the control signal from the controller circuit 2-1 controls the DC voltage-driven driver circuit 2-2 to produce the first signal having a desired amplitude and frequency, wherein the first signal may be a conditioned sinusoidal AC voltage or pulse train 7. During this process, the first signal, e.g. a first AC-voltage signal in the order of 100 V-300 V (AC) is generated. The specific layout, frequency and amplitude of the AC voltage signal may be adjusted by the controller driver 2-1

The controller circuit 2-1 may be comprised by the DC voltage-driven driver circuit 2-2.

The first signal from the DC voltage-driven driver circuit 2-2 is provided at a first output of the DC voltage-driven driver circuit 2-2 to an input of a piezoelectric transformer 2-3 of the discharge device 1. The piezoelectric transformer 2-3 may be a step-up piezoelectric transformer.

The piezoelectric transformer 2-3 is configured to boost the first signal, particularly its voltage 7 by a boost factor. The boost factor may be in the range of 5 to 20. The resulting second signal provided at an output 9 of the piezoelectric transformer 2-3. The second signal may be a second AC voltage 9 that is typically higher than 1 kV.

The piezoelectric transformer 2-3 comprises a single electric output 9. Said output 9 may come in form of a single pole or a single cable.

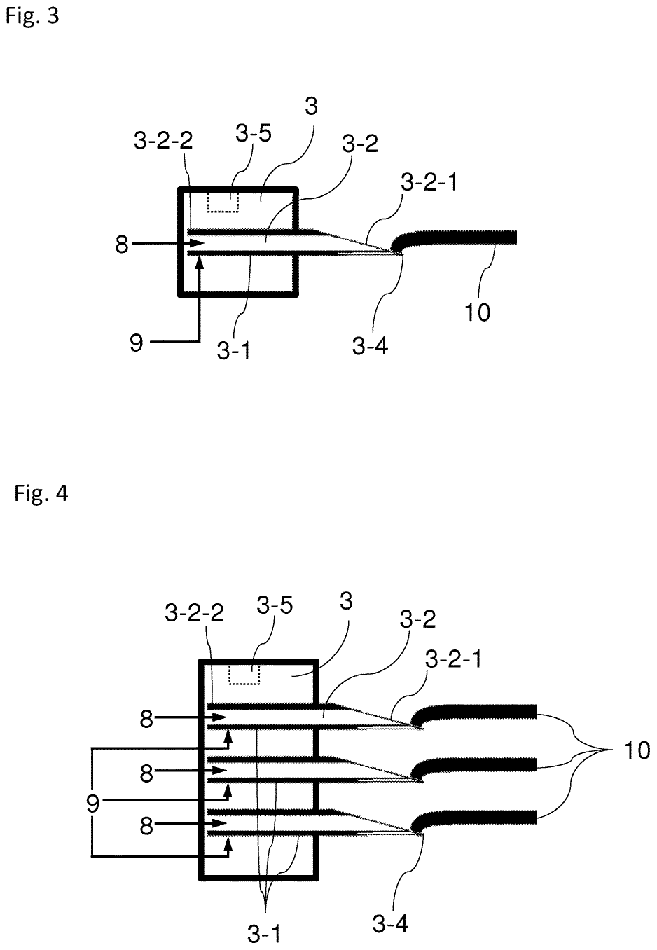

This output 9, e.g. the cable, is electrically connected to one or more electrodes (in the current example only one electrode is shown) 3-1 within a nozzle 3 of the discharge device 1, shown in FIG. 3.

The nozzle comprises a verification element 3-5 comprising an electric circuit that is configured to be detected by the controller circuit 2-1 by means of an electrical connection or by electromagnetic radio waves, such as RFID technology (depicted as a broken line). The verification element 3-5 serves for verifying the presence of the nozzle for reasons of operational security. The verification element 3-6 may comprise additional information on a nozzle ID and/or operating parameters.

The device 1 may be partially comprised in a housing 2-4. A body 2 of the device comprising the controller driver 2-1, the DC voltage-driven driver circuit 2-2, and the piezoelectric transformer 2-3 is comprised by the housing 2-4. The nozzle 3 is configured to be attached to a portion of the housing so as to form a mechanically and electrically stable but releasable connection between the body 2.

This allows for replacing the nozzle.

A flow of a feed gas may be provided to the nozzle via the body 2. The nozzle 3 is configured to distribute the flow to the one or more electrodes comprised by the nozzle 3.

In FIG. 2, a similar embodiment to that of FIG. 1 is shown. The nozzle in FIG. 2 comprises an additional opening 11 for an additional gas feed, e.g. to infuse an admix gas to the plasma or a material, e.g. particles.

In FIG. 3, an exemplary embodiment of the nozzle 3 is shown. The nozzle 3 comprises a single electrode 3-1. The electrode 3-1 is formed as a hollow tube, such as a hollow needle. The electrode 3-1 thus comprises a feed gas channel 3-2 through which a feed gas 8 may be flown to the electrode tip 3-4. At the electrode tip 3-4, the channel 3-2 has a first opening 3-2-1 at which the feed gas 8 exits the channel 3-2. The gas flow at this point should be preferably laminar.

The nozzle 3 may be made from an insulating material. The nozzle circumferentially encloses the electrode 3-1 such that a handling portion is provided that is insulated from the electrode 3-1.

During operation, i.e. when the second signal 9 is applied to the electrode 3-1 and a feed gas 8 is flown through the channel 3-1, at the electrode tip 3-4, a plasma filament 10 is formed. Depending on the gas flow, a length of the filament 10 may be adjusted.

The plasma filament 10 is formed independently of whether there is a counter electrode in the vicinity of the discharge device 1 or not. Therefore, a direction of the filament is independent of an existence of a counter electrode. In particular, the filament 10 does not “connect” to a surface that is set to ground potential, but the filament 10 may be applied to any surface.

The nozzle 3 of the device 1 is configured to be repeatedly attachable and detachable from the rest of the discharge device 1, i.e. the body of the device 1. This may be facilitated by means of a suitable connection. The nozzle 3 may comprise the verification element 3-5 configured to communicate with the controller 2-1, such that the controller circuit 2-1 may verify a presence of the nozzle 3 on the device 1.

For example, the nozzle 3 may comprise a female connection section that is attached to a male connection section on a mounting portion of the device 1.

This design also allows for secure electric contacting of the electrode 3-1 contained within the nozzle 3 to the piezoelectric transformer 2-3.

The discharge device 1 may be comprised in parts by the housing 2-4. The housing 2-4 may comprise and insulate the components generating the first signal and the second signal, i.e. the controller 2-1, the driver circuit 2-2 and the piezoelectric transformer 2-3.

Further, the housing 2-4 may extend along the nozzle 3 at least partially to shield the nozzle 3 and the electrode 3-1. At the electrode tip 3-4, the housing comprises at least an opening such that the plasma filament 10 can exit through said opening.

In FIG. 4 a similar embodiment of the nozzle 3 is shown. In addition to all the components elaborated in the context of the previous example, the nozzle 3 comprises multiple electrodes 3-1. The multiple electrodes 3-1 can be fed by a single or multiple independent feed gas 8, and can be electrically supplied by a single or multiple independent second output(s) 9.

The electrodes 3-1 may be arranged in an array or along a single line.

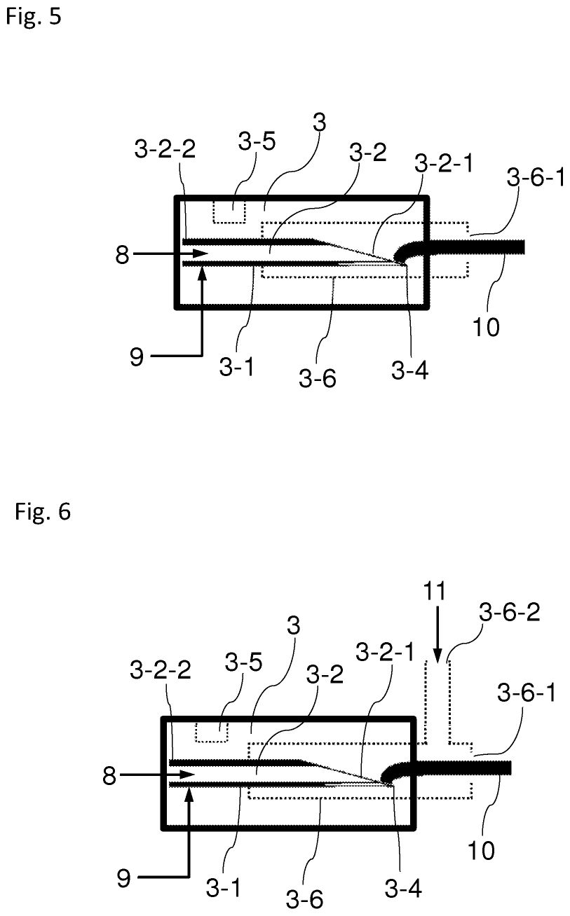

In FIG. 5 and FIG. 6, similar embodiments of the nozzle 3 of FIG. 3 are shown. In addition to all the components elaborated in the context of the previous example, the nozzle 3 comprises an additional capillary 3-6. The capillary 3-6 is arranged along the electrode 3-1 or multiple electrodes 3-1 (not shown) and comprises one or two openings. A first opening 3-6-1 is configured to allow the plasma filament 10 to exit the capillary 3-6. The second opening 3-6-2 is configured to receive additional materials 11 that are to be introduced in the plasma filament 10.

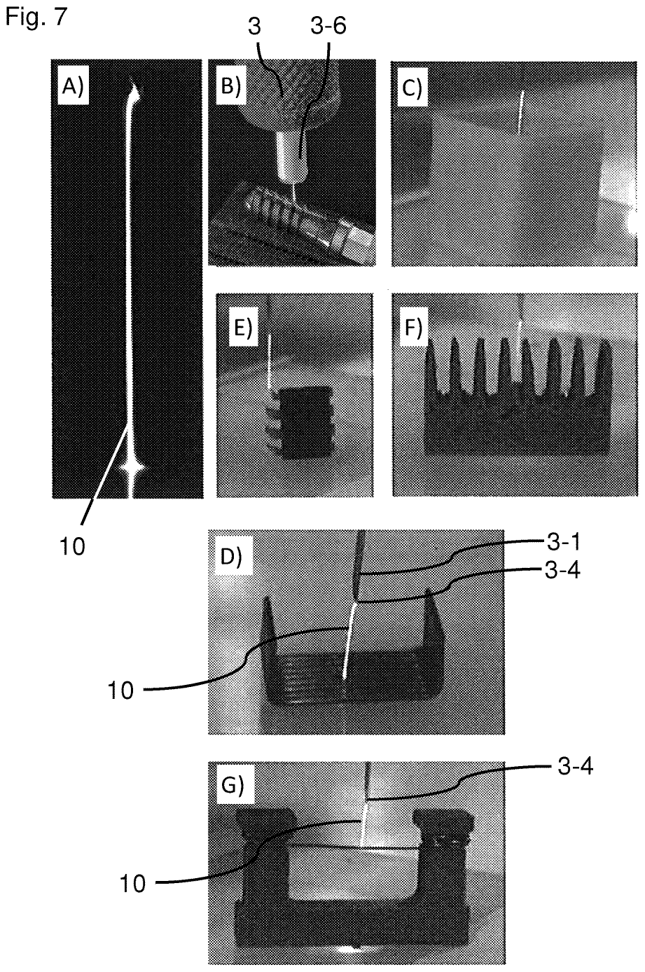

In FIG. 7, photographs of single plasma filaments generated by the discharge device 1 are shown. In each photograph, the plasma filament 10 reaches from the electrode tip to a surface or into a volume. As can be seen, in all photographs, the filaments are extremely fine and thin. The control of where the filament touches the surface is very flexible, as none of the surfaces to be treated with the filament need to put or held on ground potential.

In FIG. 7, panel A), a single filament is shown that extends between the electrode tip (not visible) and the surface to be treated (not visible).

In FIG. 7, panel B), treatment of a regular screw for a dental implant is demonstrated, wherein the filament reaches to the screw. The photograph shows the protective capillary 3-6 as well as the nozzle 3.

In FIG. 7, panel C), treatment of a non-conductive object is demonstrated. The plasma filament extends from the electrode to the object, without the object being a ground potential. In FIG. 7, panels D) to F), various examples are depicted, where the filament is used to treat objects of complex geometry, wherein the filament reaches precisely to the region of the object, where treatment is supposed to be executed without deflection due to protruding object features.

In FIG. 7, panel G), it is demonstrated that the plasma filament can be precisely adjusted and aligned to treat as small wire or fiber.

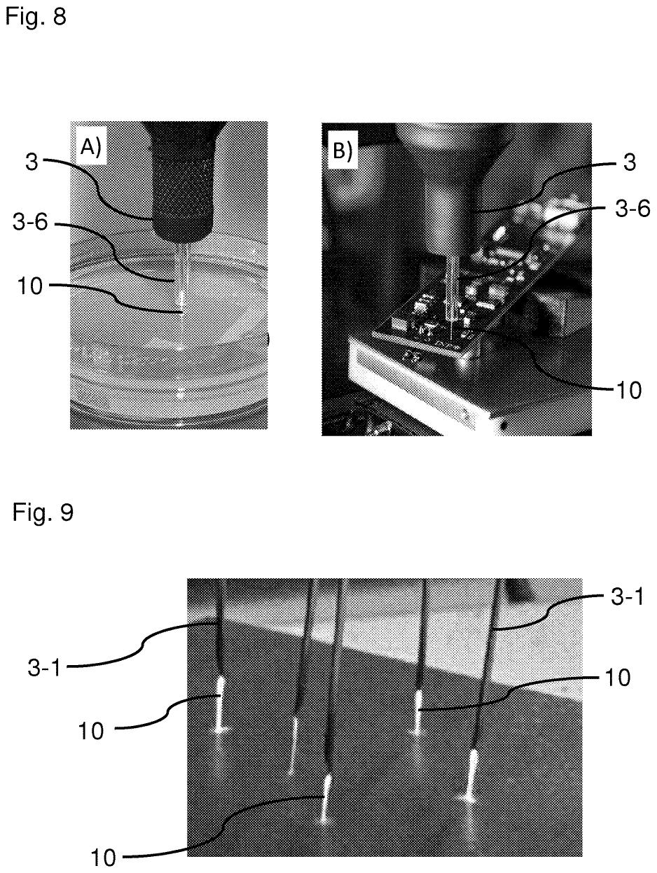

In FIG. 8, embodiments of the discharge device are shown comprising a protective capillary for the electrode. The discharge device in FIG. 8, panel A) is used to treat a gel sample, wherein the same device is used to treat an electronic circuit with electronic components on a circuit board in FIG. 8, panel B).

FIG. 9 depicts an embodiment of the discharge device comprising a plurality of electrodes comprised by a single nozzle of the discharge device. Multiple plasma filaments fed by a single gas source 8 and a single AC voltage or pulse train output 9 are demonstrated in FIG. 9.

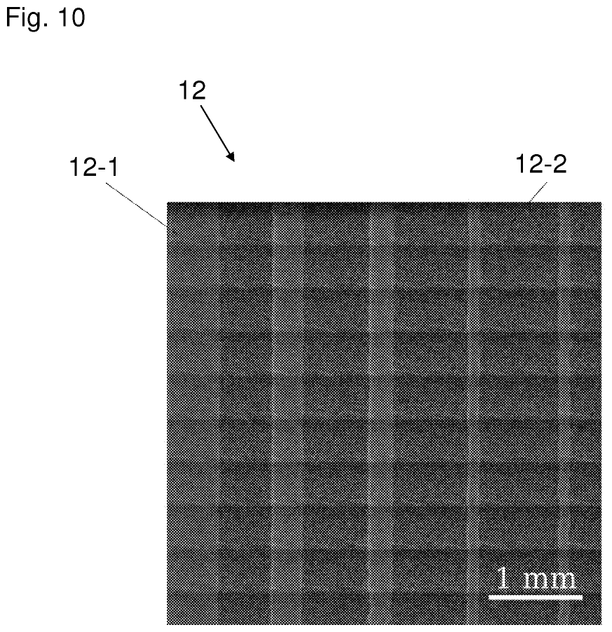

FIG. 10 illustrates an XPS image showing a silicon substrate 12-1 having a Teflon film 12-2 deposited thereon. The Teflon film 12-2 has been selectively removed from the substrate by applying the discharge device according to the method of the invention.

In the XPS image, the silicon substrate 12-1 appears as light gray areas, while the remaining Teflon film 12-2 is represented by dark gray areas. The vertical lines in the image correspond to areas where the Teflon film 12-2 has been removed, exposing the underlying silicon substrate 12-1.

The regular pattern of vertical lines demonstrates the precision and spatial resolution achievable using the discharge device and method of the invention. The lines may be accurately generated with well-defined edges, indicating the controlled nature of the removal process.

The XPS image in FIG. 10 showcases the capability of the discharge device to perform selective removal of thin films, such as a Teflon film 12-2, from substrates like a silicon substrate 12-1. This selective removal process may be useful in various applications, including microelectronics fabrication, surface patterning, and material modification. In particular, removing Teflon from a silicon wafer is typically considered to be almost impossible using plasma etching techniques.

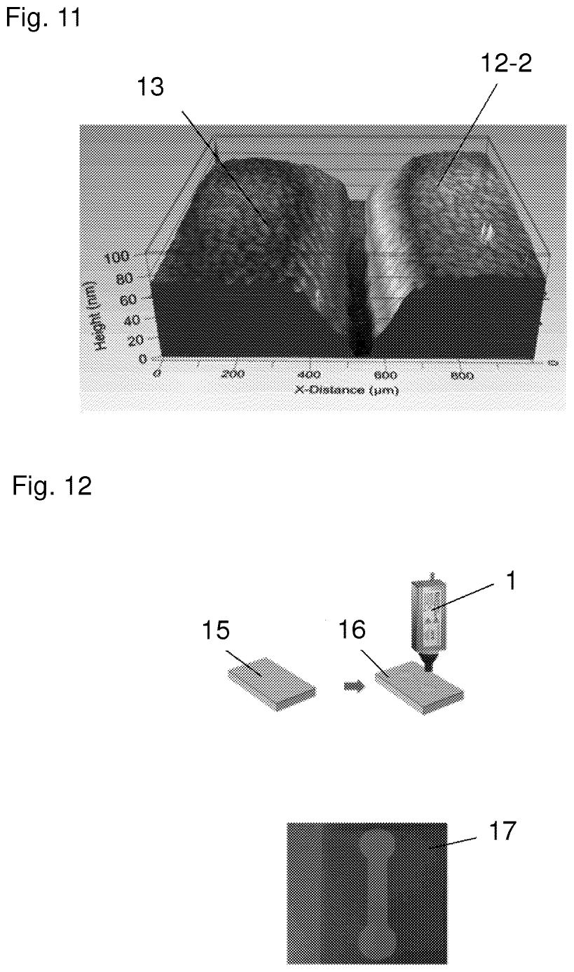

FIG. 11 illustrates a 3D surface profile 13 of a substrate that has been etched using the discharge device applied via the method according to the invention. The 3D surface profile 13 shows a silicon substrate coated with a Teflon film 12-2 and a silicon dioxide layer that has been selectively removed. The 3D surface profile 13 demonstrates the high-precision etching capabilities of the discharge device. The etched regions exhibit steep edges, indicating a sharp transition between the removed and remaining portions of the Teflon film 12-2. This steep edge profile may be attributed to the nature of the extremely thin plasma filament generated by the discharge device.

In some cases, the 3D surface profile 13 reveals a high line resolution achieved during the etching process. The etched lines or patterns may have well-defined boundaries, suggesting precise control over the removal of the Teflon film 12-2.

In particular, FIG. 12 shows a discharge device 1 performing a direct writing single-step process 16 on a substrate 15.

In this process, the discharge device 1 may be used to directly write a desired structure onto the substrate 15 without the need for a mask using a gas-phase or liquid-phase precursor. The direct writing single-step process 16 may involve generating a plasma filament at the tip of the discharge device 1 and moving the device relative to the substrate 15 to create the desired pattern 17, while feeding the precursor into the plasma filament.

FIG. 12 also depicts a substrate after writing process 17, which shows the result of the writing process. After the writing process 17, the substrate may exhibit a pattern or a structure created by the direct writing single-step process 16. This pattern may be precisely controlled by the movement and operation of the discharge device 1.

In some cases, the direct writing single-step process 16 may allow for high-resolution patterning of the substrate 15. The process may enable the creation of complex structures or patterns without the need for traditional photolithography techniques or masks.

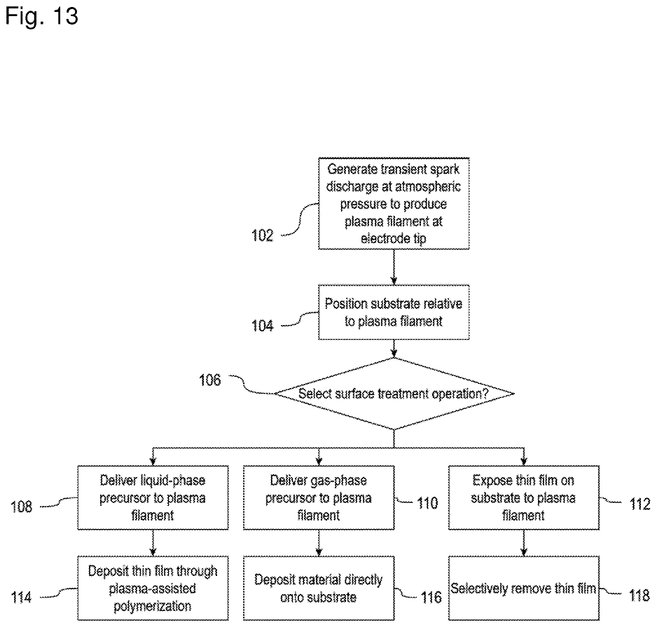

FIG. 13 illustrates a flowchart for a plasma-assisted surface treatment method according to an exemplary embodiment of the invention. The method may begin with generating 102 a transient spark discharge at atmospheric pressure to produce a plasma filament at an electrode tip of the device. Before or after this step 102, a substrate may be positioned 104 on a system comprising the discharge device 1, such as to expose the substrate to the plasma filament.

The method allows for three possible paths based on the selected surface treatment operation: additive printing, direct writing, or maskless etching.

For additive printing, the method involves delivering 108 a liquid-phase precursor or a gas-phase precursor to the plasma filament. This is followed by depositing 114 a thin film through plasma-assisted polymerization of the precursor.

In the case of direct writing, a gas-phase precursor 110 is delivered to the plasma filament. Subsequently, material is deposited 116 directly onto the substrate.

For maskless etching, the method exposes 112 the substrate covered by a thin film to the plasma filament such as to selectively remove 118 the thin film from the substrate.

The flowchart illustrates how the method adapts based on the selected surface treatment operation, allowing for different procedures to be executed using the same discharge device or system. With the device according to the invention, high-aspect ratio writing, additive manufacturing and/or etching may be facilitated using the same device on a wide variety of substrate and thin film combinations.

### REFERENCE NUMERALS

1 discharge device
2 first portion of the discharge device containing the electronics/body
2-1 controller driver
2-2 DC voltage-driven driver circuit
2-3 piezoelectric transformer
2-4 housing
3 nozzle or second portion of the discharge device
3-1 electrode
3-2 hollow channel
3-2-1 first channel opening
3-2-2 second channel opening
3-4 electrode tip
3-5 verification element
3-6 protective capillary
3-6-1 capillary outlet
3-6-2 capillary inlet
4 control signal input
5 control signal output
6 DC voltage input
7 first signal
8 feed gas
9 second signal
10 plasma filament
11 additional material
12 XPS image
12-1 silicon substrate
12-2 Teflon film
13 3D surface profile
15 substrate
16 direct writing single-step process
17 substrate after writing process

1. A transient spark discharge device (1) configured to generate an atmospheric pressure plasma filament (10) comprising the following components:
a controller circuit (2-1) connected to and configured to control a DC-voltage-driven driver circuit (2-2) configured to generate a first signal at a first output (7), wherein the controller circuit is configured to control at least one signal property of the first signal, such as an amplitude, a frequency and/or a shape of the first signal, wherein the first output (7) is electrically connected to a piezoelectric transformer (2-3), wherein the piezoelectric transformer is configured to generate a second signal at a second output (9), wherein the second output (9) is electrically connectable or connected to a nozzle (3) comprising one or more electrically conductive electrodes (3-1) connectable or connected to the second output (9), wherein each electrode (3-1) comprises a conductive electrode tip (3-4), wherein each electrode comprises a hollow channel (3-2) with a first opening (3-2-1) at its electrode tip (3-4) and a second opening (3-2-2) at an opposite end of the channel (3-2), such that a feed gas (8) may be flown from the second opening (3-2-2) to the first opening (3-2-1) for replenishing the feed gas (8) at the electrode tip (3-4),
wherein the second signal is configured to cause a transient spark discharge at each electrode tip (3-4) of the one or more electrodes, such as to generate a transient plasma filament (10) at each electrode tip (3-4).

2. The discharge device (1) of claim 1, wherein each electrode (3-1) is formed as a hollow needle, wherein a needle tip of the needle corresponds to the electrode tip (3-4).

3. The discharge device (1) according to claim 1, wherein the DC-voltage-driven driver circuit (2-2) comprises a DC voltage input (6), wherein the DC-voltage-driven driver circuit (2-2) is arranged and configured to generate from a DC-voltage applied to the DC voltage input (6) the first signal having the at least one signal property as controlled by the controller circuit (2-1).

4. The discharge device (1) according to claim 1, wherein the discharge device (1) is configured to generate the transient plasma filament (10) independently of a presence of a grounded counter electrode in a vicinity to the discharge device (1).

5. The discharge device (1) according to claim 1, wherein the discharge device (1) comprises a mounting system that comprises a first portion (2) located on the discharge device and a second portion located on the nozzle (3), wherein the first and the second portion are configured to engage the one or more electrodes (3-1) with the discharge device (1).

6. The discharge device (1) according to claim 1, wherein the discharge device (1) is configured to generate at each electrode tip a plasma filament (10) having a diameter in the range of 5 μm to 200 μm.

7. The discharge device (1) according to claim 1, wherein the discharge device (1) comprises one or more capillaries (3-6), wherein each capillary encloses one of the one or more electrodes (3-1) at least radially.

8. The discharge device according to claim 1, wherein the discharge device (1) comprises a gas source attached or attachable to the second opening (3-2-2) of the channel (3-2) of the one or more electrodes (3-1), wherein the gas source is configured to flow a feed gas (8) or a feed gas mixture from the second opening (3-2-2) through the channel of each electrode toward the first opening (3-2-1) of the channel (3-2).

9. The discharge device (1) according to claim 3, wherein the DC voltage is in the range of 0V to 24 V.

10. The discharge device (1) according to claim 1, wherein the first signal comprises a waveform selected from the group consisting of:
a sinusoidal waveform,
a pulse train,
a sawtooth waveform, and
a triangular waveform,
a composite waveform.

11. The discharge device (1) according to claim 1, wherein the second signal comprises a waveform selected from the group consisting of:
a sinusoidal waveform,
a pulse train,
a sawtooth waveform,
a triangular waveform, and
a composite waveform.

12. The discharge device (1) according to claim 1, wherein the gas source is configured to provide a gas flow between 0.1 sccm and 500 sccm.

13. The discharge device (1) according to claim 3, wherein the discharge device (1) comprises a housing that encloses the controller circuit (2-1), the DC-voltage-driven driver circuit (2-2) and the piezoelectric transformer (2-3), wherein the housing (2-4) is connectable or connected to the nozzle (3), wherein the nozzle (3) has an opening through which the one or more electrodes (3-1) or the corresponding electrode tips (3-4) is arranged such as a plasma filament (10) may exit the nozzle (3).

14. The discharge device (1) according to claim 1, wherein the piezoelectric transformer (2-3) is a step-up piezoelectric transformer.

15. The discharge device (1) according to claim 1, wherein the discharge device is configured as a handheld device or mountable on a machine set up, allowing orienting the discharge device use in any direction.

16. The discharge device (1) according to claim 1, wherein the piezoelectric transformer (2-3) comprises a plurality of piezoelectric transformer devices connected in series, such that each piezoelectric transformer device feeds into the next piezoelectric transformer device of the plurality of piezoelectric transformer devices to increase the second signal at the second output (9).

17. A plasma printing system comprising the transient spark discharge device of claim 1, wherein the system further comprises:
a substrate handling platform configured to position and secure a substrate for plasma treatment;
a multi-axis linear stage or a robotic arm configured to enable precise movement of the transient spark discharge device relative to the substrate;
a gas supply system or systems configured to provide a feed gas, a feed gas mixture or a gas-phase precursor to the transient spark discharge device;
a liquid-phase precursor dispensing system, such as a mist generator, aerosol generator, or droplet-on-demand system, configured to deliver precursors for plasma-assisted deposition; and
a controller configured to coordinate the operation of the transient spark discharge device, the substrate handling platform, and the dispensing system.

18. The plasma printing system of claim 17, further comprising a vacuum clamping system for securing the substrate during plasma printing or etching operations on the substrate handling platform.

19. A method for plasma-assisted surface treatment with the device according to claim 1, the method comprising the steps of:
generating a transient spark discharge at atmospheric pressure to produce a plasma filament at the tip of one or more electrodes;
positioning a substrate relative to the plasma filament, particularly using the substrate handling platform; and
performing a surface treatment operation selected from the group consisting of:
additive printing using a liquid-phase precursor,
additive printing or direct writing using a gas-phase precursor, and
maskless etching of thin films.

20. The method of claim 19, wherein the plasma filament is generated using a sinusoidal-based transient spark discharge and a feed gas selected from the group consisting of argon, helium, or a mixture thereof, with an optional addition of reactive gases in concentrations less than 5%.
